(19) United States
(12) Patent Application Publication
(10) Pub. No.: US 2017/0281459 A1
(43) Pub. Date: Oct. 5, 2017

(54) STIMULATION DEVICE WITH CHANGE OF SHAPE USING SHAPE-MEMORY ELEMENT

(71) Applicant: LAVIU GMBH, Dresden (DE)

(72) Inventor: Martin CIRILLO-SCHMIDT, Halle a.d. Saale (DE)

(73) Assignee: LAVIU GMBH, Dresden (DE)

(21) Appl. No.: 15/507,019

(22) PCT Filed: Sep. 8, 2015
(86) PCT No.: PCT/EP2015/070485

§ 371 Date: Feb. 27, 2017

(30) Foreign Application Priority Data
Sep. 8, 2014 (DE) 102014112874.5

(51) Int. Cl. A61H 19/00; A61H 23/02

(52) U.S. Cl. CPC A61H 19/44; A61H 23/02; A61H 2201/0207; A61H 2201/1664; A61H 2201/149

(57) ABSTRACT

A stimulation device includes a base body, and a contact element attached on or in the base body, for contact with a body part of the user. The contact element has a reversibly deformable contact surface region. A shaping element, to generate a local deformation of the contact element without deforming the base body, is arranged on or in the base body to move in relation to the base body. An actuation device is arranged on or in the base body and operatively connected to the shaping element to generate movement of the shaping element. The actuation device comprises a shape-memory element that can be deformed by applying an electrical current and/or a magnetic field and/or by changing the temperature, and is connected to the base body on one side and to the shaping element on the other side, and, by deforming, causes a movement of the shaping element.

The invention relates to a stimulation device with change of shape, which can be used, for example, as a sex aid or as a therapeutic aid, like a massage device or an exercise device.

Massage devices are generally used to mechanically influence the skin, connective tissue and muscles by exerting stimuli that cause stretching, tightening and pressure. The massage effect spreads from the treated site of the body through the whole organism and also influences the psyche.

From practice, massage devices are known which change their external shape. Thus, there are massage devices which can be pneumatically inflated and thereby change their volume and, consequently, their shape. Massage devices are also known which are able to enlarge their volume by means of a mechanical rotating and sliding technique.

DE 10 2012 109 409 A1 discloses a vibrator with a housing, with a silicone sleeve connected to the housing, and with an electric motor that generates vibrations.

Moreover, DE 10 2006 005 358 A1 discloses a dildo, of which the dildo body is composed of a cylindrical part and a front end and has electrical heating means and connecting elements for connecting to a power source, wherein the heating means are in the form of a heating film arranged in a tubular configuration in the cylindrical part.

According to U.S. Pat. No. 6,599,236 B1, a dildo has a heating element in the form of a heating coil which can be regulated by a thermostat in order to bring the dildo to a desired temperature.

The material of such massage devices or dildos is often a rubber-elastic material.

DE 10 2012 019 842 A1 discloses a massage device with at least one rubber-elastically deformable wall, with at least one actuator, which is arranged and configured to act on a sub-region of the elastically deformable wall, thus deforming same, wherein the actuator is formed with an electroactive polymer, and the actuator is electrically connected to a control unit arranged in or directly on the massage device and can be actuated by means of this control unit.

The massage function is provided here by a deformation element in the interior of a rubber-elastic outer wall, which deformation element outwardly deforms the outer wall in sub-regions. For this purpose, a force has to be continuously applied which, along with the frictional forces arising in the interior of the device, leads to very high energy consumption.

A disadvantage of the known solutions is that the massage devices have a predefined massage function which cannot subsequently be altered and in most cases also cannot be adapted to anatomical differences in order to achieve the best possible stimulation.

Another disadvantage of the known solutions is that an electrically driven motor is often needed to generate movement. During operation, electric motors that generate vibrations produce annoying and undesired noises, and they are subject to unavoidable wear.

As is known, the current for the electrical drive is made available by means of batteries or accumulators. These batteries or accumulators have only a limited useful life and need to be charged or replaced, which involves effort on the part of the user.

The object of the present invention is to make available a stimulation device which overcomes the disadvantages of known stimulation devices. This object is achieved by the invention specified in the claims. Advantageous embodiments are the subject matter of the dependent claims.

The object is achieved by a stimulation device which comprises a base body and a contact element which is mounted on or in the base body, is intended for contact with a body part of a user and has at least one reversibly deformable contact surface region, wherein at least one shaping element, designed to generate a local deformation of the contact element without deforming the base body, is arranged on or in the base body so as to be movable in relation to the base body, and at least one actuator is arranged on or in the base body and is operatively connected to the shaping element in order to generate a movement of the at least one shaping element, which actuator comprises at least one shape-memory element which is deformable by application of an electrical current and/or of a magnetic field and/or by change of temperature, which shape-memory element is connected at one end to the base body and at the other end to the shaping element and, by deformation, causes a movement of the at least one shaping element.

The proposed stimulation device can specifically be used, for example, as a vibrator, a dildo, a penis ring, a masturbator, an artificial vagina, a butt plug, a penis cuff, Ben Wa balls, a dilator and the like. The stimulation device is advantageously suitable for use as a sex aid or therapeutic aid for the stimulation of erogenous zones and/or of the muscles, such as the vaginal and anal muscles.

An outer surface of the stimulation device, i.e. a surface accessible to a user, is formed by a contact element which is intended for contact with a body part of a user and which either forms the entire surface of the stimulation device or the greater part of the surface of the stimulation device or only a relatively small part of the surface of the stimulation device. This contact element has at least one sub-region which is reversibly deformable and which is referred to below as a contact surface region. A contact element of this kind can be made, for example, of rubber-elastic material such as silicone, latex, thermoplastic elastomers or the like. It can be secured, for example, on a base body. The contact element can be secured on the base body such that the surface of the stimulation device accessible to the user is formed partially by the base body and partially by the contact element. However, the contact element can also completely or partially envelop the base body.

A stimulation effect is achieved by the fact that, on the side of the contact element directed away from the user, a shaping element is arranged movably in such a way that a movement of the shaping element causes a local deformation of the contact element, more precisely of the reversibly deformable contact surface region, or moves such a deformation across the surface directed toward the user. The movement of the shaping element in turn is effected by a shape-memory element which experiences a change of shape under the influence of an electrical current, a magnetic field or a change of temperature. For example, a shape-memory element of this kind changes one dimension, in the case of a wire or thin rod, for example, its length. A shape-memory element of this kind is produced, for example, from a so-called shape-memory alloy (SMA). This group of materials includes, for example, alloys such as NiTi, NiTiCu, CuZn, CuZnAl, CuAlNi, FeNiAl, FeMnSi and ZnAuCu. A shape-memory element of this kind can, for example, be strip-shaped, wire-shaped, plate-shaped, band-shaped, spiral-shaped, etc., its shape being chosen in accordance with the desired function. The induced change of shape, which is utilized to drive a movable shaping element, can be an extension, for example, a lengthening or shortening, a bending or also a twisting.

The shape-memory elements can, for example, have dimensions of between 0.01 mm and 20 mm in cross section and of between 10 mm and 200 mm in length. Moreover, for example, the shape-memory elements can be designed in the form of a technical spring (for example a helical spring, torsion spring or bending spring) with a wire diameter of between 0.01 mm and 5 mm. They can, for example, have activation temperatures of between 15° C. and 100° C.

Moreover, two or more shape-memory elements made of different shape-memory materials may be present which, for example, change their shape at different temperatures or magnetic fields. The shape-memory alloys that can be used can have a one-way shape memory effect and/or a two-way shape memory effect and/or a pseudo-elastic behavior. Materials with different effects and behaviors can be used depending on the desired function of the stimulation.

With shape-memory alloys, the change of shape can usually be induced thermally or magnetically. Both effects can be exploited. A thermally induced change of shape can be obtained by passing an electric current through the shape-memory element, such that the shape-memory element heats on account of its resistance (direct thermal excitation), or the temperature of the shape-memory element is changed from the outside, for example by delivering or withdrawing heat, for example by a heating or cooling means or by changing the ambient temperature, for example by the action of body heat (indirect thermal excitation).

For example, shape-memory alloys can be used which have no change of shape at temperatures higher than the use temperature and which change their shape when the temperature drops to the use temperature. For example, the stimulation device can be heated to a temperature of 50 to 60° C., after which, during use for stimulation of skin or muscles, it cools to room temperature and in so doing deforms.

Moreover, this thermally induced change of shape can also be obtained by shape-memory alloys which have no change of shape at temperatures lower than the use temperature and which change their shape when the temperature rises to the use temperature. For example, the stimulation device can be present as is at room temperature and, upon insertion into vaginal or anal openings and upon a temperature increase to body temperature of ca. 38° C., can be heated and in so doing deform.

However, the thermal activation can also be achieved by passing through an electric current and using the resulting heat of the resistance, by a heating element or heating medium, for example a heating rod, or by a chemical exothermal reaction, for example a sodium acetate trihydrate solution.

The change of shape of the shape-memory element, which is produced either by current flowing through the shape-memory element, by production of a magnetic field passing through the shape-memory element or by a change in the temperature of the shape-memory element, and which causes the movement of the shape-memory element, is noiseless and therefore superior to known stimulation devices. In addition, the use of a shape-memory element as the drive means for a movable shaping element permits an almost inertia-free, i.e. very rapidly responsive, actuation of the drive of the shaping element across broad frequency ranges and with a very finely adjustable amplitude of the movement that is generated.

With the proposed stimulation device, it is possible, through a change of shape, to exert several stimulation functions acting successively or simultaneously and to thereby obtain better stimulation of the respective stimulation region.

Possible shape changes which can be generated, and which the proposed stimulation device can adopt by activation of the shape-memory alloy, include curving, rounding, bending, alternate rising and falling, changes of direction, expansions or changes of length or spiral formations. With insertion of further elements, these changes of shape can lead to additional changes of shape of the outer sleeve.

With this stimulation device, individual regions of a contact face of the stimulation device, for example of an outer sleeve, can change their shape in succession or simultaneously. For example, it is thus possible to achieve a single change of shape during use, a pseudo-elastic multiple change of shape and/or a change of the change of shape during use, wherein each change of shape can be brought back after use to the starting state.

An elastic sleeve can in this case be designed for example such that it presses the one or more shaping elements back to their original shape, or the one or more shape-memory elements readopt their starting shapes after the excitation has ended.

As has already been described above, the at least one shaping element can be movable to and fro between a first position and a second position, wherein the at least one shaping element, in the first position, does not deform the contact surface region and, in the second position, does deform the contact surface region.

For example, the deformable contact surface region can be non-deformed in the first position of the shaping element and therefore the surface of the stimulation device directed towards the user can be smooth, while the shaping element in its second position causes a local deformation of the contact surface region, which for example brings about a thickening of the stimulation device. However, an individual shaping element can also be designed such that, in the second position, it generates two or more deformations such as closely adjacent bulges of the contact surface region or the like.

However, the at least one shaping element can also be movable to and fro between a first position and a second position such that the at least one shaping element deforms the contact surface region both in the first position and the second position, and the deformation generated by the shaping element moves across the contact surface region during the movement of the shaping element. In other words, the deformation migrates across the surface of the stimulation device directed toward the user.

Moreover, provision can be made that the actuator has at least one restoring element that counteracts the movement of the at least one shaping element or an extension of the at least one shape-memory element. Such a restoring element can be, for example, an elastic element such as a spring or the like, but also an additional shape-memory element. If the restoring element acts on the shaping element, the extension of the shape-memory element is reversed by the operative connection between shaping element and shape-memory element, while the restoring element in the other case acts directly on the shape-changing element and reverses the extension of the latter.

According to one embodiment, provision is made that the actuator has a transmission means connected in a force-transmitting manner to at least one shape-memory element and to at least one shaping element. Such a transmission means can, for example, have a movement-converting function. For example, an extension of a shape-memory element that acts linearly can be converted into a rotating or pivoting movement of the shaping element. Alternatively or in addition, a transmission means can be configured such that it strengthens or weakens a movement of a shaping element generated by the extension of a shape-memory element. For example, a transmission means can be designed as a gear.

For this purpose, for example, provision can be made that the transmission means has at least one lever and/or at least one scissor mechanism and/or at least one crank disk and/or at least one guide element. A guide element in this sense can, for example, be a linear guide for guiding a shaping element along a straight guide path or along a guide curve.

According to a further embodiment, provision can be made that at least two shaping elements are operatively connected to each other. The operative connection between the two or more shaping elements can be such that the coupled shaping elements act on the contact element in the same direction or in different directions. Here, two or more shaping elements acting on the contact element in the same direction means that the coupled shaping elements do not generate any deformation in their respective first position and do generate deformation in their respective second position, i.e. they always generate a deformation simultaneously, or a movement from their respective first position to their respective second position causes a movement of the respective deformation in the same direction, i.e. the deformations generated by the shaping elements move together in the same direction. Two or more shaping elements acting on the contact element in opposite directions means that the coupled shaping elements always generate a deformation in alternation, or the deformations generated by the shaping elements move in opposite directions.

Moreover, provision can be made that two shape-memory elements with opposite directions of action are operatively connected to the one or more shaping elements. This can be exploited either to drive two shaping elements in opposite directions, for example, as has already been described above, or to reverse an extension of a shape-memory element by the action of a further shape-memory element, as has likewise already been described above.

According to one embodiment, provision is made that the base body is formed as a first housing part, which receives the shape-memory element or the shape-memory elements, and at least one shaping element is designed as a second housing part, which is connected movably to the first housing part. For example, a first housing part and one or more second housing parts can together form a housing defining the outer configuration of the stimulation device, where the one or more second housing parts, on account of their relative mobility with respect to the first housing part, jointly or individually cause a local deformation of the stimulation device.

Moreover, provision can be made that the contact element intended for contact with a body part of a user is designed as a rubber-elastic sleeve which encloses at least the base body and the one or more shaping elements. If the base body and the one or more shaping elements together form a housing defining the outer configuration of the stimulation device, the sleeve can be shaped according to this outer configuration, such that it bears tightly on the housing parts. During a movement of a shaping element, the sleeve is thereby elastically deformed in the area around said shaping element, such that the stimulation device becomes thicker for example.

According to a further embodiment, provision can be made that at least one energy reservoir for storing electrical energy is arranged on or in the base body. Although it is also possible for the electrical energy required for operating the stimulation device to be supplied from the outside, for example by means of the stimulation device being connected to a power cable, it is advantageous, for good maneuverability of the stimulation device, if the latter is cordless. This can be achieved by arranging an energy reservoir directly on or in the stimulation device.

In one embodiment, provision is made that the energy reservoir comprises at least one rechargeable accumulator. This avoids the user having to open the stimulation device in order to replace non-rechargeable batteries as soon as they have run out.

Advantageously, provision can also be made that at least one receiver coil for contactless supply of electrical energy is arranged on or in the base body. In this way, for example, an accumulator arranged in the stimulation device can be charged contactlessly. Metallic contacts on the outside of the stimulation device are therefore not needed, as a result of which the stimulation device is even safer to use and can easily be made watertight.

According to a further embodiment, provision can be made that a control unit for influencing the movement of the one or more shaping elements is arranged on or in the base body and is electrically connected to the one or more shape-memory elements and/or to an electromagnet and/or to a heater. For example, the control unit can be designed such that it emits a pulsating or continuous signal. Here, “pulsating signal” means that, between two movement procedures in which a shaping element is moved from a first position to a second position and back, no movement takes place during a certain time span. By contrast, in the case of a “continuous signal”, a movement from the first position to the second position and back takes place in constant alternation, without the shaping element coming to a rest. If the stimulation device has several shaping elements which are each operatively connected independently of one another to a shape-memory element and are driven by the latter, then the individual shaping elements can advantageously be actuated independently of each other and separately from each other. In this way, complex stimulation programs can be implemented.

Moreover, provision can be made that the control unit is designed to periodically actuate the one or more shape-memory elements in the frequency range of 5 Hz or less, preferably 3 Hz or less, in particular 1 Hz or less. Known stimulation devices vibrate at frequencies that are many times above these values. The stimulating action of such stimulation devices is based on stimulation, by high-frequency solid movement of the device, of body parts that come into contact with it. It has been found that stimulation based on a periodic, low-frequency local application of force to treated body parts creates a much more pleasant and more intensive stimulating action. This type of stimulation is considered to be particularly pleasant at the stated frequencies, likewise the local action on treated body parts of a user.

In another embodiment, provision is made that it moreover has at least one operating element for setting a frequency and/or strain amplitude of at least one shape-memory element.

For example, it is possible for frequency and/or amplitude to be influenced directly by the user. For this purpose, for example, a button for switching the stimulation device on and off can be provided. Moreover, for example, a button for setting the frequency and a button for setting the amplitude can be provided for each individually controllable shaping element, in which case the frequency and the amplitude are either increased or decreased continuously, as long as the respective button is actuated, or the frequency and the amplitude are increased or decreased in steps each time the corresponding button is pressed. Likewise, a pair of buttons can be provided in each case for setting the frequency and the amplitude, of which one causes an increase and the other a decrease in the frequency and the amplitude, respectively.

In other embodiments, it is possible for frequency and/or amplitude to be influenced indirectly by the user. For this purpose, for example, the stimulation device can have stimulation programs which are stored in the control unit and which generate different combinations of frequencies and amplitudes, wherein both the frequency and the amplitude can be varied during the course of a program. Alternatively, the programs can also be stored in an app configured on a mobile terminal. Such an app can at the same time be configured as a remote control for the stimulation device.

In the same way as has been described above for the user choice of frequency and/or amplitude, the stored programs can likewise be retrieved via an operating element, for example. For this purpose, for example according to one embodiment, an individual button can be provided which, when first pressed, switches the stimulation device on and retrieves a first stored program. If the button is pressed a second time, the next stored program is retrieved, and so on, until all of the stored programs have been chosen once. If the button is pressed again thereafter, this causes the stimulation device to switch off. According to another embodiment, one button is used for switching on and off and a further button is used for program selection. Alternatively, a pair of buttons can be provided for program selection, of which one button retrieves the stored programs in ascending order and the other button retrieves the stored programs in descending order.

It will be appreciated that, instead of buttons, other operating elements can likewise be used, for example toggle switches, rotary switches and the like. A particular advantage of buttons is that they can be easily protected from water by being arranged under or behind a rubber-elastic contact element, for example a silicone sleeve, since they can still be operated without any problem by virtue of the elastic property of the sleeve.

However, solutions are also included in which the one or more operating elements are component parts of a remote control, such that no operating elements have to be arranged on the stimulation device itself. If the remote control is an app on a mobile terminal, the operating elements can be configured in the form typical for apps, for example as buttons, slides or the like which are operated by touch and are presented on the screen of the mobile terminal, and of which the functions can correspond to those of the buttons described above.

Illustrative embodiments of proposed stimulation devices are explained in more detail below with reference to the figures in the drawings, in which:

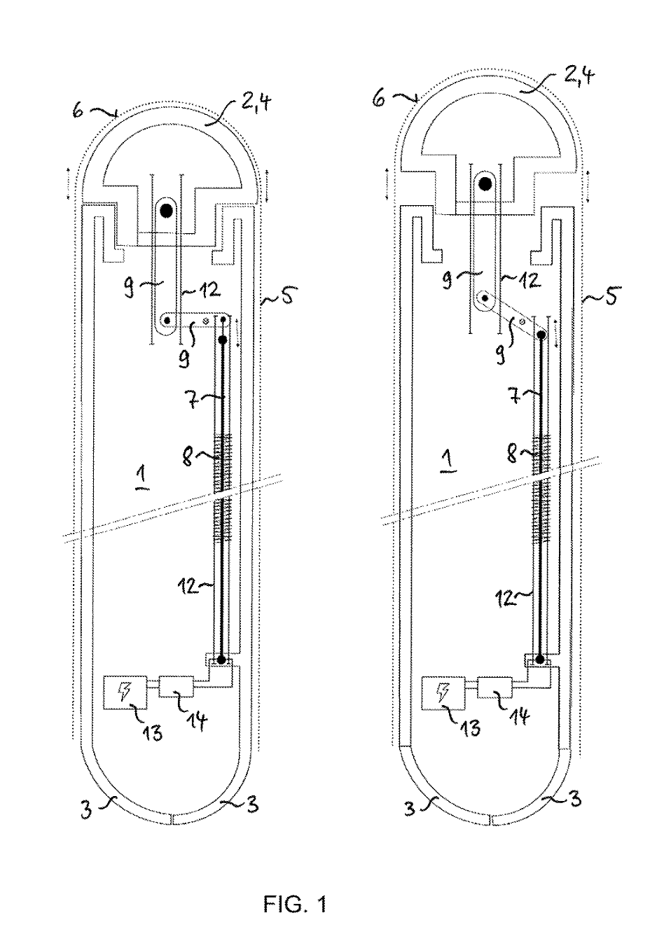

FIG. 1 shows a stimulation device according to a first illustrative embodiment;

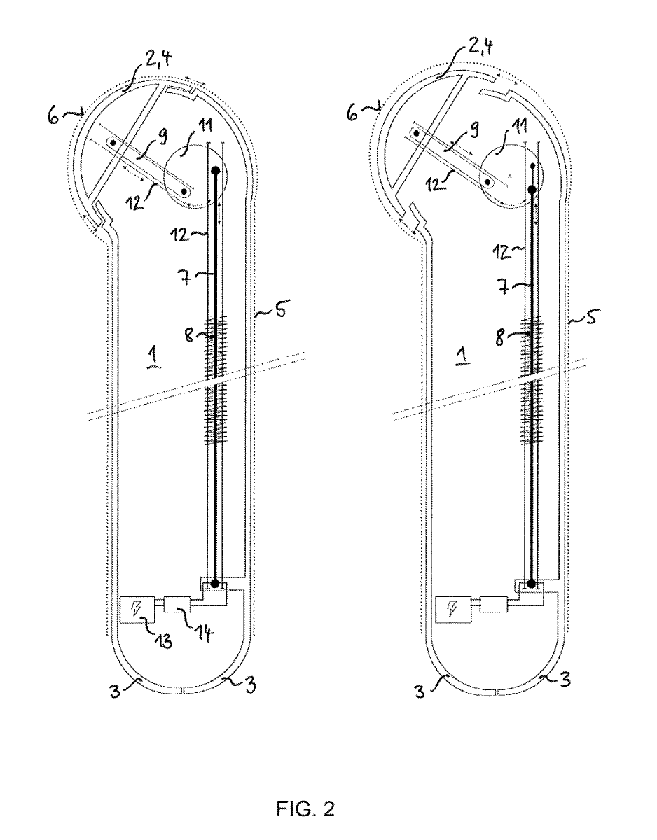

FIG. 2 shows a stimulation device according to a second illustrative embodiment;

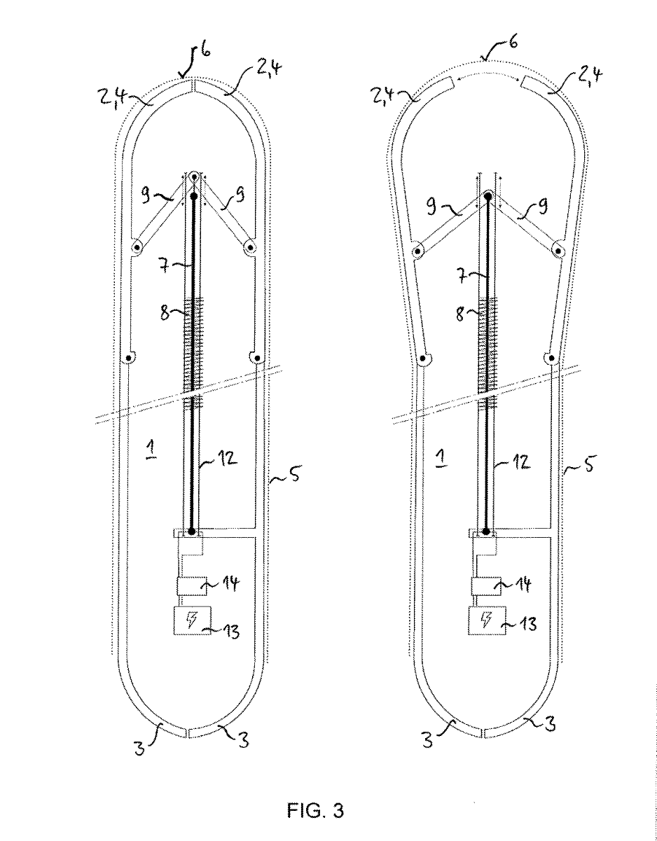

FIG. 3 shows a stimulation device according to a third illustrative embodiment;

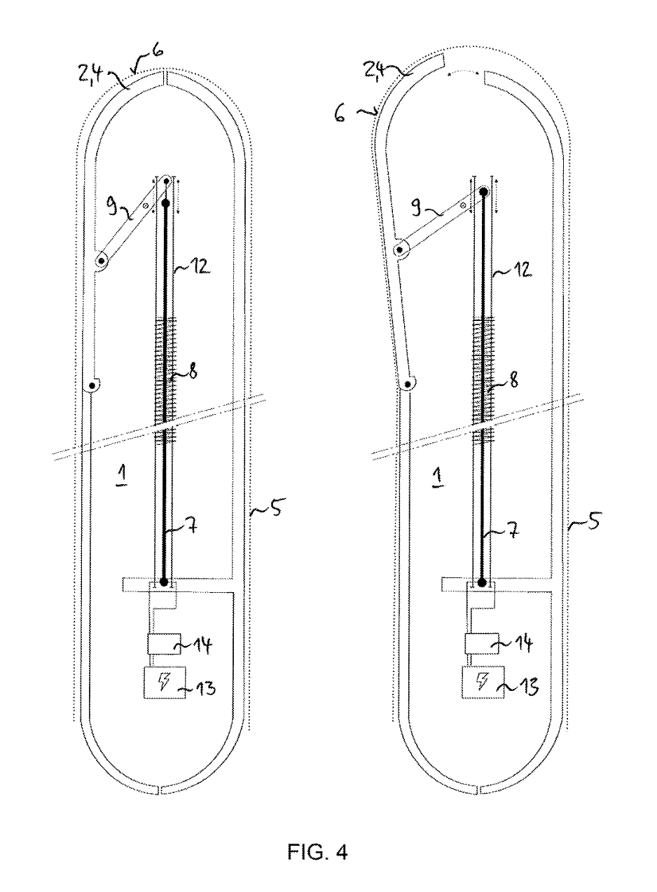

FIG. 4 shows a stimulation device according to a fourth illustrative embodiment;

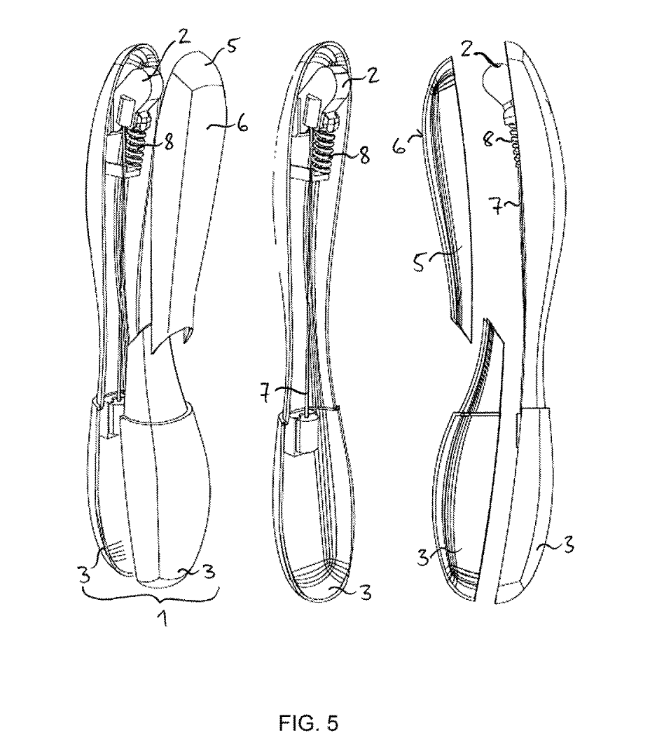

FIG. 5 shows a stimulation device according to a fifth illustrative embodiment;

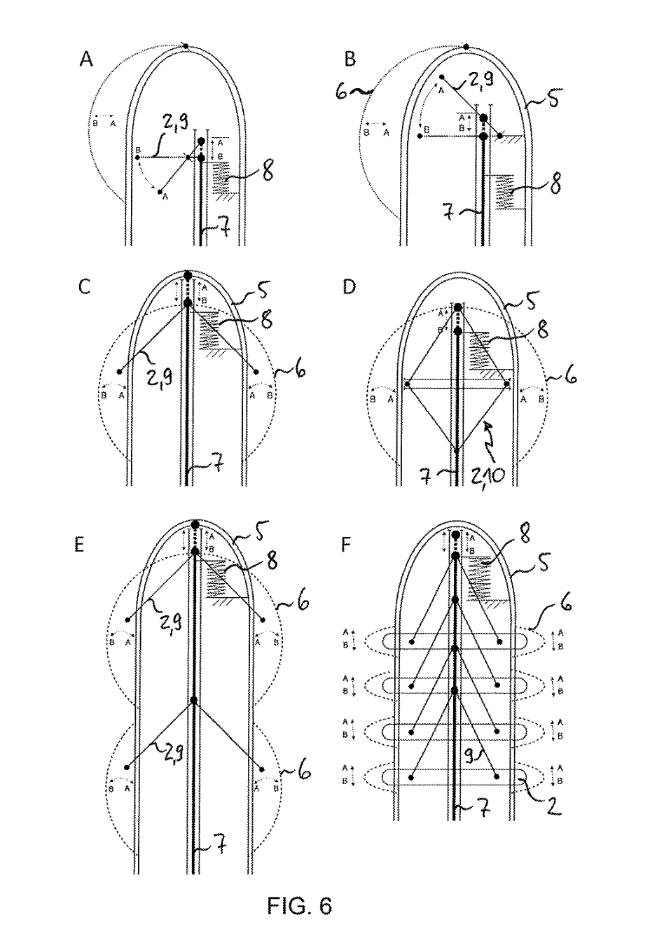

FIG. 6 shows six illustrative embodiments of various other proposed mechanisms of action.

Each of FIGS. 1 to 4 shows a schematic longitudinal section through an example of a stimulation device according to various illustrative embodiments. In all of the cases shown, a contact element intended for contact with a body part of a user is arranged on an outer face of a rod-shaped housing. However, the principles and mechanisms depicted are likewise applicable in illustrative embodiments which have another form, for example stimulation devices with a hollow cylindrical housing or base body in which a contact element intended for contact with a body part of a user forms an inner surface of the hollow cylinder.

In the illustrative embodiments shown, a contact element 5 is in each case designed as an elastic outer sleeve made of silicone. The contact element 5 encloses a base body 1 formed from two first housing parts 3. In each of the illustrative embodiments according to FIGS. 1, 2 and 4, a shaping element 2 is arranged movably on the base body 1 and is at the same time designed as a second housing part 4. In the illustrative embodiment according to FIG. 3, two shaping elements 2 are arranged movably on the base body 1 and are each designed at the same time as a second housing part 4. The first housing parts 3 and the one or more second housing parts 4 together define the basic shape of the stimulation device, which is delimited to the outside by the contact element 5.

A shape-memory element 7 is in each case arranged in the interior of the stimulation device and, in the illustrative embodiments shown, is designed as a tensioned wire made of shape-memory alloy and is guided by guide elements 12. The shape-memory element 7 is in each case arranged in the base body 1 and is operatively connected at one end to a first housing part 3 and at the other end to the shaping element 2 or, in the illustrative embodiment according to FIG. 3, to the two shaping elements. In the starting state, the shape-memory element 7 is subject to tensile loading by a restoring element 8 which, in the illustrative embodiments, is designed as a compression spring.

The shape-memory element 7 is electrically connected to an energy reservoir 13 which, in the illustrative embodiments, is in each case designed as a rechargeable accumulator, and to a control unit 14, such that a flow of current through the shape-memory element can be generated, wherein the electrical connection is shown highly schematically. The control unit 14 can be operated by the user via one or more buttons, for example.

As soon as current flows through the shape-memory element 7, the latter draws together counter to the applied tensile stress. As soon as there is no longer any current flowing through, the restoring element 8 pulls the shape-memory element 7 back to the starting length. By suitable programming of the control unit 14, the shape-memory element 7 can be actuated in a pulsed manner and thus generates a pulsating movement of the one or more shaping elements 2, which thereby cause a deformation of a reversibly deformable contact surface region 6 of the contact element 5.

To produce the operative connection between the shape-memory element 7 and the one or more shaping elements 2, transmission means are formed by levers 9 in the illustrative embodiments. In the illustrative embodiment according to FIG. 3, a crank disk 11 assumes the function of the lever. In the illustrative embodiments, levers 9, which are component parts of the respective guides, are guided in guide elements 12.

In the illustrative embodiments in FIGS. 1 and 2, the shaping elements 2 each have a dome shape and are linearly movable by alternate lengthening and shortening of the shape-memory element 7. By contrast, the shaping elements 2 in the illustrative embodiments in FIGS. 3 and 4 are mounted on a first housing part 3 in an articulated manner and are pivotable about the articulated bearing, as a result of which a deformation of the deformable contact surface region 6 of the contact element 5 is obtained.

In the illustrative embodiment according to FIG. 5, a shaping element 2 is arranged in an articulated manner in a base body 1 formed from two first housing parts 3. The contact element 5 does not cover the whole stimulation device, but only the areas that are not closed by first housing parts 3. The shaping element 2 is operatively connected to a restoring element 8 in the form of a compression spring. A shape-memory element is connected at one end to a first housing part 3 and at its other end directly to the shaping element 2. An electrical actuation of the shape-memory element 7 causes a pivoting movement of the shaping element 2, as a result of which the deformable contact surface region 6 of the contact element is locally deformed.

FIG. 6 shows six illustrative embodiments of various other mechanisms of action that are proposed by the invention. These are extremely schematic depictions which do not show all the features of the respective stimulation device, since they are merely intended to illustrate how a stimulation device according to the invention can be designed.

In FIGS. 6A and 6B, the deformation is effected in the simplest way by a pivot lever, which locally deforms the contact element 5. In the case of FIG. 6A, the lever 9 is moved from the bottom upward when the shape-memory element 7 is actuated. In the case of FIG. 6B, the lever 9 is moved from the top downward when the shape-memory element 7 is actuated. This corresponds to the principle of action of the illustrative embodiment in FIG. 5. In specific embodiments, for example, the lever 9 itself can at the same time be the shaping element 2.

In the illustrative embodiments in FIGS. 6C and 6D, a deformation of the contact element 5 is achieved by two or more levers 9 which, for example, can be distributed about the circumference of the stimulation device. In the case of FIG. 6C, the shape-memory element 7 is connected at the highest point to the contact element 5. If the free ends of the levers 9 are also connected to the contact element, the levers 9 spread open when the shape-memory element 7 shortens, such that the contact element 5 is deformed. In the case of FIG. 6D, four levers are connected to one another in the manner of a scissor mechanism 10 and are guided in the horizontal direction in guide elements 12, such that a shortening of the shape-memory element 7 causes an outward movement of the connection points of the levers, and this in turn leads to a deformation of the contact element 5.

In the illustrative embodiments in FIGS. 6E and 6F, a deformation of the contact element 5 is effected or moved equally at several points. The illustrative embodiment according to FIG. 6E is similar to that of FIG. 6C, except that in this case two pairs or groups of levers 9 are present, which are operatively connected to the same shape-memory element 7 and are operated by the latter in the same direction. By contrast, the illustrative embodiment according to FIG. 6F is an example of a stimulation device that has several pairs or groups of levers 9 which are operatively connected to one and the same shape-memory element 7 and are each connected to a shaping element 2, wherein each shaping element 2 permanently causes a deformation of the contact element 5. An actuation of the shape-memory element 7 in this case causes a movement of the shaping elements 2 along the longitudinal axis of the stimulation device and, consequently, a movement of the deformations that are generated.

### LIST OF REFERENCE SIGNS

1 base body

2 shaping element

3 first housing part

4 second housing part

5 contact element

6 deformable contact surface region

7 shape-memory element

8 restoring element

9 lever

10 scissor mechanism

11 crank disk

12 guide element

13 energy reservoir

14 control unit

1. A stimulation device, comprising: a base body, and a contact element which is mounted on or in the base body, for contact with a body part of a user and having at least one reversibly deformable contact surface region, wherein at least one shaping element to generate a local deformation of the contact element without deforming the base body, is arranged on or in the base body so as to be movable in relation to the base body, and at least one actuator is arranged on or in the base body and is operatively connected to the at least one shaping element in order to generate a movement of the at least one shaping element, which actuator comprises at least one shape-memory element deformable by application of an electric current and/or of a magnetic field and/or by change of temperature, which shape-memory element is connected at one end to the base body and at the other end to the at least one shaping element and, by deformation, causes a movement of the at least one shaping element.

2. The stimulation device as claimed in claim 1, wherein the at least one shaping element is movable to and fro between a first position and a second position, wherein the at least one shaping element, in the first position, does not deform the contact surface region and, in the second position, does deform the contact surface region.

3. The stimulation device as claimed in claim 1, wherein the at least one shaping element is movable to and fro between a first position and a second position, wherein the at least one shaping element deforms the contact surface region in the first position and the second position, such that the deformation moves across the contact surface region during the movement of the at least one shaping element.

4. The stimulation device as claimed in claim 1, wherein the actuator has at least one restoring element which counteracts the movement of the at least one shaping element or an extension of the at least one shape-memory element.

5. The stimulation device as claimed in claim 1, wherein the actuator has a transmission means connected in a force-transmitting manner to the at least one shape-memory element and to the at least one shaping element.

6. The stimulation device as claimed in claim 5, wherein the transmission means has at least one lever and/or at least one scissor mechanism and/or at least one crank disk and/or at least one guide element.

7. The stimulation device as claimed in claim 1, wherein the at least one shaping element comprises at least two shaping elements operatively connected to each other.

8. The stimulation device as claimed in claim 1, wherein the at least one shape-memory element comprises two shape-memory elements with opposite directions of action operatively connected to the at least one or more shaping elements.

9. The stimulation device as claimed in claim 1, wherein the base body comprises at least one first housing part, which receives the at least one shape-memory elements, and a second housing part which comprises the at least one shaping element, which is connected movably to the at least one first first housing part.

10. The stimulation device as claimed in claim 1, wherein the contact element for contact with a body part of a user comprises a rubber-elastic sleeve which encloses at least the base body and the at least one shaping elements.

11. The stimulation device as claimed in claim 1, further comprising at least one energy reservoir for storing electrical energy arranged on or in the base body.

12. The stimulation device as claimed in claim 11, wherein the energy reservoir comprises at least one rechargeable accumulator.

13. The stimulation device as claimed in claim 1, further comprising at least one receiver coil for contactless supply of electrical energy arranged on or in the base body.

14. The stimulation device as claimed in claim 1, further comprising a control unit, for influencing the movement of the at least one shaping element, arranged on or in the base body and electrically connected to the at least one shape-memory elements and/or to an electromagnet and/or to a heater.

15. The stimulation device as claimed in claim 14, wherein the control unit configured to periodically drive the at least one shape-memory elements in a frequency range of 5 Hz or less, preferably 3 Hz or less, in particular 1 Hz or less.

16. The stimulation device as claimed in claim 1, further comprising at least one operating element for setting a frequency and/or strain amplitude of at least one shape-memory element.

17. The stimulation device as claimed in 15, wherein the frequency range comprises 3 Hz or less.

18. The stimulation device as claimed in 15, wherein the frequency range comprises 1 Hz or less.
